(19) United States
(12) Patent Application Publication
(10) Pub. No.: US 2006/0251255 A1
(43) Pub. Date: Nov. 9, 2006

(54) System and method for utilizing a wireless communication protocol in a communications network

(76) Inventor: Puneet Batta, San Clara, CA (US)

Correspondence Address: FAY KAPLUN & MARCIN, LLP, 15O BROADWAY, SUITE 702, NEW YORK, NY, 10038, US

(21) Appl. No.: 11/110,015

(22) Filed: Apr. 20, 2005

(51) Int. Cl. H04K 1/00

(52) U.S. Cl. 380/270

(57) ABSTRACT

Described is a system including a wireless access point and a computing device. The wireless access point has a first wireless protocol and communicates with a wireless device which has a second wireless protocol. The access point and the wireless device are configured to conduct wireless communications using the first and second wireless protocols. The computing device has a third wireless protocol and is coupled, via a wire, to the access point. The computing device conducts communications with at least one of the access point and the wireless device using the third wireless protocol.

### BACKGROUND

In a conventional wireless network, communication between a wireless access point and a computing device (e.g., a switch) attached thereto by a wired connection is inherently insecure. That is, a signal transmitted via the wired connection is unencrypted, and therefore capable of being intercepted. An unauthorized user can intercept the signal and access data contained therein by employing sniffing, spoofing, and other techniques.

One conventional method for securing communications over the wired connection is the Internet Protocol Security (“IPsec”) protocol which utilizes a public key encryption system to encode the communications. Implementing the IPSec protocol typically requires significant changes to a hardware and/or firmware of the access point representing significant costs in upgrades and maintenance. Additionally, the IPSec protocol does not support multicasting (i.e., communications between a single sender and multiple receivers), because each signal requires a separate encryption step prior to transmission to each receiver. For example, a multicast signal addressed for three receivers would be encrypted and transmitted three times. Thus, there is a need for secure communication between the access point and the devices wired thereto, while eliminating costs and limitations associated with the IPsec protocol.

### SUMMARY OF THE INVENTION

The present invention relates to a system including a wireless access point and a computing device. The wireless access point has a first wireless protocol and communicates with a wireless device which has a second wireless protocol. The access point and the wireless device are configured to conduct wireless communications using the first and second wireless protocols. The computing device has a third wireless protocol and is coupled, via a wire, to the access point. The computing device conducts communications with at least one of the access point and the wireless device using the third wireless protocol.

### BRIEF DESCRIPTION OF THE DRAWINGS

FIG. 1 shows an exemplary embodiment of a system according to the present invention;

FIG. 2 shows an exemplary embodiment of a computing device according to the present invention;

FIG. 3 shows an exemplary embodiment of a method of communication from an access point to a computing device according to the present invention; and

FIG. 4 shows an exemplary embodiment of a method of communication from a computing device to an access point according to the present invention.

### DETAILED DESCRIPTION

The present invention may be further understood with reference to the following description and the appended drawings, wherein like elements are referred to with the same reference numerals. The exemplary embodiment of the present invention describes a system and a method for communication in a wireless network containing one or more wireless access points and one or more computing devices attached thereto via one or more wire connections. The present invention further describes a computing device which supports communication according to the system of the present invention.

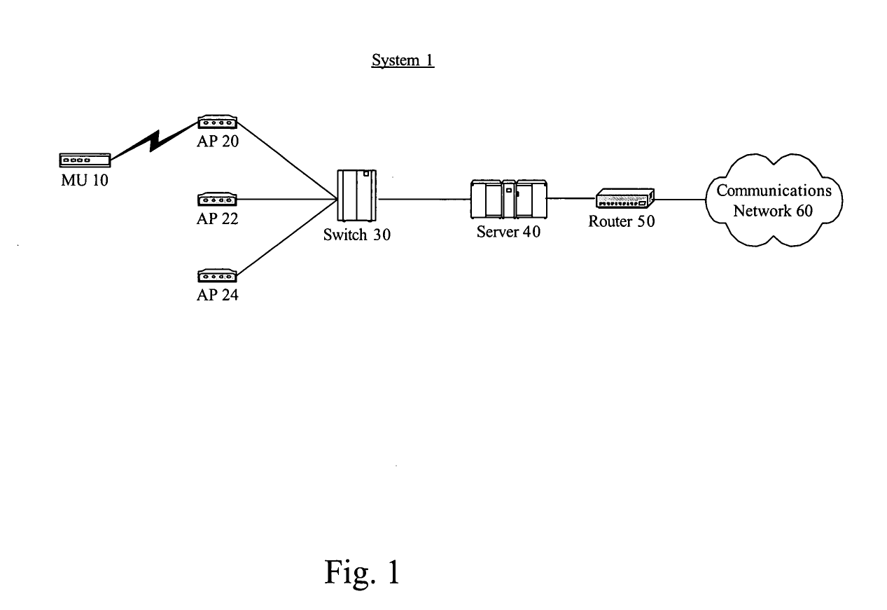

FIG. 1 shows an exemplary embodiment of a system 1 according to the present invention. The system 1 may include one or more wireless devices (e.g., a mobile unit “MU” 10) in wireless communication with one or more access points (“APs”) 20, 22, 24. The wireless communication between the MU 10 and the AP 20 may be conducted according to a predefined communication protocol, such as, for example, an IEEE 802.11x standard. Those of skill in the art will understand that the MU 10 is capable of communicating with each of the APs 20-24, but may associate, and thus communicate, with only one AP (e.g., the AP 20) for a predetermined time and/or until a predetermined condition occurs (e.g., roaming out of a range of the AP 20). The AP 20 may have an architecture including a processor, one or more antennas, one or more transmitters, and one or more receivers.

Although FIG. 1 shows only the MU 10 in wireless communication with the AP 20, those of skill in the art would understand that the system 1 may include any number and type of MUs (e.g., PDAs, cell phones, scanners, laptops, handheld computers, etc.). Those of skill in the art would further understand that the MU 10 may include a non-mobile unit attached to the wireless device (e.g., a PC or a laptop with a network interface card).

Each AP 20-24 may be connected to one or more computing devices (e.g., a switch 30) via a wired connection. Those of skill in the art will understand that the system 1 of the present invention may be utilized by any computing device which is connected, either directly or indirectly, to one or more of the APs 20-24, via the wired connection. According to the present invention, the switch 30 may be further connected to one or more data devices (e.g., a server 40) which are connected to a communications network 60 (e.g., an Internet, a WLAN). In one embodiment, the server 40 is connected directly to the communications network 60, while in another embodiment the server 40 is connected to the communications network 60 via a router 50. Those of skill in the art will understand that the APs 20-24, the MU 10, the switch 30, and the server 40 may comprise a network. Also, although the present invention will be described with reference to the AP 20, the teachings of the present invention can be extended to any AP in the system 1.

The router 50 directs a path of a transmission when communicated between two or more networks connected thereto. In the system 1, the router 50 directs the path of the transmissions from the server 40 and the communications network 60. The router 50 determines a destination of the transmission and directs the transmission thereto. The router 50 may, for example, direct transmissions intended to remain within a network of the server 40, or alternatively, the router 50 may direct transmissions intended to pass from the network of server 40 to the communications network 60, and vice-versa.

In the system 1, the server 40 may communicate with the AP 20 and/or the MU 10 via the switch 30 and/or to the communications network 60 via the router 50. The server 40 may fulfill an intra-network request. For example, the MU 10 may request a data value from the server 40. The server 40 may also fulfill an inter-network request. For example, the server 40 receives the request from the communications network 60 via the router 50.

Radio frequency (“RF”) signals may be communicated between the MU 10 and the AP 20 over a preselected radio channel. During wireless communication between the MU 10 and the AP 20, the communications may be encrypted by a processor or a dedicated circuit (e.g., an encryption circuit) in either using a wireless encryption protocol (e.g., a Wired Equivalent Privacy (“WEP”), wi-fi protected access (“WPA”), WPA2, AES-CCMP/802.11i) prior to transmission. Thus, the wireless encryption protocol may be a software application executed by the processor or may be hardwired on the dedicated circuit. Although the exemplary embodiment of the present invention will be described with reference to the wireless encryption protocol, those of skill in the art will understand that further wireless protocols (e.g., a key management/exchange protocol, etc.) may be utilized herewith.

In one exemplary embodiment, the MU 10 encrypts the communication prior to transmission to the AP 20. Those of skill in the art will understand that the AP 20 may conduct a similar process when transmitting a further communication to the MU 10. Generally, upon receipt, the AP 20 decrypts the communication using a built-in wireless encryption protocol (e.g., the WEP), and creates a frame (e.g., a control frame or a data frame) which is transmitted to the switch 30 via the wired connection therebetween. The frame may be unencrypted and may be, for example, a configuration, a heartbeat, a status and/or a statistic frame. Those skilled in the art will understand that the built-in wireless encryption protocol provides the AP 20 with a capability to encrypt the communications transmitted to the MU 10. Thus, the wireless encryption protocol and the built-in wireless encryption protocol are similar in that they provide for decryption of encrypted transmissions between the MU 10 and the AP 20.

After the AP 20 receives the communication from the MU 10, the frame is transmitted to the switch 30 via the wired connection thereto. In the conventional system, the AP 20 would decrypt the frame, and optionally re-encrypt the frame using an IPsec protocol, before transmitting it to the switch 30. According to the present invention, the AP 20 and the switch 30 may encrypt and decrypt the frames communicated therebetween utilizing a wireless encryption protocol.

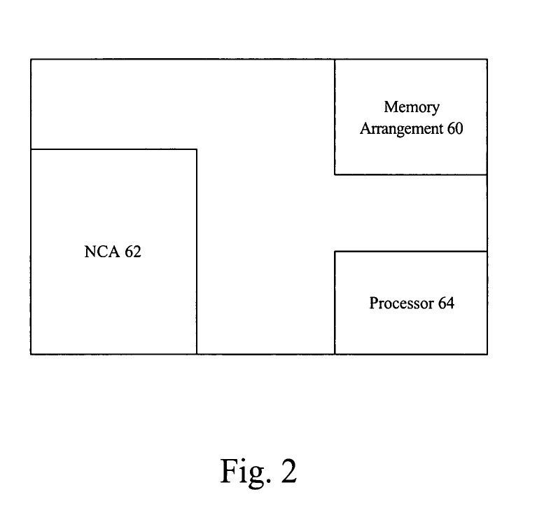

An exemplary embodiment of the switch 30 according to the present invention is shown in FIG. 2. The switch 30 may include a memory arrangement 60, a network communication arrangement (“NCA”) 62, and a processor 64. The memory 60 may be any storage device capable of having data written thereto and read therefrom. Examples of the memory arrangement include, but are not limited to, SRAM, EPROM, ROM, and other similar arrangements. In addition, the memory 60 may be a combination of both a volatile and a non-volatile memory. The memory 60 may include one or more stored wireless encryption protocols. According to the present invention, the stored wireless encryption protocol is compatible with the wireless encryption protocol utilized by the AP 20. That is, any encryption performed by the AP 20 may be decrypted by the switch 30, and vice-versa, which will be described more completely below.

The NCA 62 provides for communication between the AP 20 and the switch 30 via the wired connection. The NCA 62 may further allow for communication between the switch 30 and, for example, the server 40. The NCA 62 may be a hardware configuration which would provide for the communicative abilities of the switch 30. For example, the hardware configuration may be one or more ports (e.g., serial, parallel, USB, etc.) which receives the wired connection from the AP 20 and, optionally, the server 40. For example, referring back to FIG. 1, the switch 30 may be connected to each AP 20-24 and the server 40 via the NCA 62.

The processor 64 controls communication between the switch 30 and any device connected thereto. The processor 64 may be a microcontroller, application-specific integrated circuit, or other hardware configuration capable of processing data and accessing applications and/or data stored in the memory 60. In conjunction with the NCA 62, the processor 64 directs a path of a transmission between two or more devices connected to the switch 30. For example, the processor 64 may establish a connection between the AP 20 and the server 40 when, for example, the communication received by the AP 20 from the MU 10 is addressed for the server 40. According to the present invention, the processor 64 may also encrypt and decrypt a transmission received by the switch 30. For example, upon receipt of the frame from the AP 20 and/or the server 40, the processor 64 may access the memory 60 and execute an encryption or decryption procedure utilized by the stored wireless encryption protocol stored therein. This process will be described in more detail below.

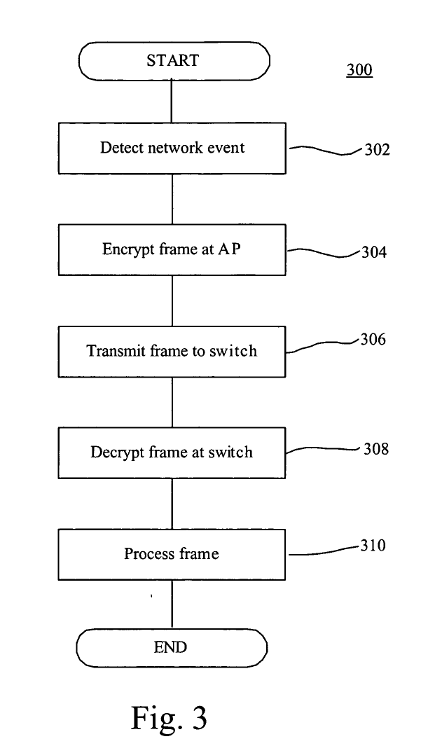

FIG. 3 shows an exemplary embodiment of a method 300 according to the present invention. The method 300 generally describes communication between the AP 20 and the switch 30, and in particular, a transmission from the AP 20 to the switch 30. In step 302, a network event is detected by the AP 20. The network event may include, but is not limited to, detection of the MU 10 within a coverage area of the AP 20, loss of communication between the AP 20 and the MU 10, and receiving the communication from the MU 10. The network event may cause or require an adjustment of a setting on the MU 10, the AP 20, the switch 30 and/or the server 40. Examples of the adjustment include, but are not limited to, changing the power level of the AP 20, transferring communication with the MU 10 to a further AP (e.g., AP 22), and specifying the preselected radio channel for use by the MU 10 and the AP 20. To effect the adjustment, the AP 20 may generate and transmit one or more frames to the server 40 and/or the switch 30. For example, if the MU 10 is moving away from the AP 20 towards the AP 22, the AP 20 may detect a change in a characteristic (e.g., signal strength) of the signal from the MU 10 and transmit this information to the server 40 and/or the switch 30. Further examples of the network event include when the AP 20 collects one or more statistics which it may transmit to the switch 30 at predetermined intervals, and when the MU 10 attempts to authenticate itself to the switch 40 and generate a session key for encryption. In the latter example, the switch 40 may transmit the session key(s) to the AP 20 allowing it to encrypt/decrypt communications from the MU 10.

In step 304, the frame is encrypted by the AP 20 using the built-in wireless encryption protocol. In one embodiment, the AP 20 decrypts the communication received from the MU 10 and then generates and encrypts the frame using the built-in wireless encryption protocol. In another embodiment, the AP 20 generates the frame based on the network event, independent of communication with the MU 10. Those skilled in the art will understand that the built-in wireless encryption protocol used in this step may be any wireless encryption protocol (e.g., WEP, Wi-Fi Protected Access (“WPA”), WPA2, Advanced Encryption Standard-Counter Mode CBC-MAC Protocol (“AES-CCMP”)/802.11i, etc.) utilized for encryption/decryption by the AP 20 during wireless communication.

In step 306, the encrypted frame is transmitted by the AP 20 to the switch 30 via the wired connection. Those of skill in the art will understand that whether the frame includes the communication from the MU 10 or is generated by the AP 20, the frame will be addressed to the switch 40.

In step 308, the switch 30 decrypts the frame using the stored wireless encryption protocol in the memory 60. As described above, the stored wireless encryption protocol of the switch 30, the wireless encryption protocol of the MU 10 and the built-in wireless encryption protocol of the AP 20 are functionally equivalent in that the frame may be encrypted and decrypted by each of the switch 30, the MU 10 and the AP 20.

In step 310, the switch 30 processes the frame. That is, the frame may include information which requires a response from a receiver thereof. For example, if the MU 10 remains within the range of the AP 20 and signals received from the AP 22 are weaker than those from the AP 20, the switch 30 may instruct the AP 20 to increase a power level to maintain and/or facilitate communication with the MU 10. As stated above, the transmitted by the AP 20 to the switch may be the control and/or data frame (e.g., statistics, status, etc.).

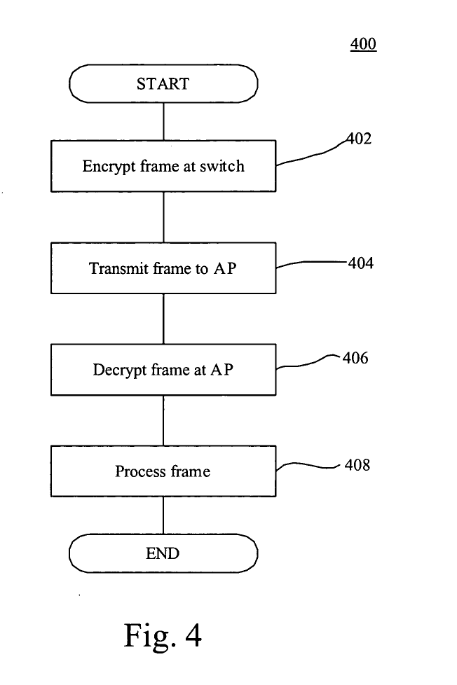

FIG. 4 shows an exemplary embodiment of a method 400 according to the present invention. The method 400 generally describes communications between the AP 10 and the switch 30, and in particular, a transmission from the switch 30 to the AP 20. In step 402, the switch 30 encrypts the frame from the server 40 using the stored wireless encryption protocol. In this embodiment, the frame may include an instruction from, for example, the server 40. The instruction may be embodied as one or more control frames and/or one or more data frames. For example, the server 40 may instruct the AP 20 to adjust the power level thereof. In another embodiment, the switch 30 may generate and encrypt a frame originating therefrom.

In step 404, the encrypted frame is transmitted to the AP 20 via the wired connection. In step 406, the AP 20 decrypts the frame using the built-in wireless encryption protocol. Upon decrypting the frame, in step 408 the AP 20 processes the frame. For example, the AP 20 recognizes the instruction in the frame which requires the AP 20 to increase the power level. Thus, the AP 20 performs a predetermined action (e.g., boosts the power level) in response to the instruction.

A further advantage of the system 1 according to the present invention relates to a multicast (e.g., the server 40 needs to transmit the same instruction to each of the APs 20-24). According to the present invention, the APs 20-24 have a unique security key for a unicast frame and a shared broadcast key for a multicast frame. The multicast frame originating at the server 40 is transmitted to the switch 30. In another embodiment, the multicast frame may originate at the switch 30. The switch 30 encrypts the multicast frame using the shared broadcast key and transmits the multicast frame to each of the APs 20,22,24. Each AP 20,22,24 decrypts the multicast frame using the shared broadcast key and independently processes the information (e.g., the instruction) therein. Thus, the data is encrypted only once before being transmitted to each of the APs 20,22,24.

The system 1 according to the present invention may be applied to any wired communication between the APs 20,22,24 and the switch 30. The system 1 may be applied, for example, to key exchanges and authentication between the MU 10 and the server 40. As known to those skilled in the art, the AP 20 includes built-in wireless security protocols in addition to the built-in wireless encryption protocol. The protocols include authentication protocols and key management protocols, such as those built into the IEEE 802.1X standards.

In a further embodiment of the present invention, the MU 10 may be authenticated prior to communication in the system 5. After the MU 10 is authenticated, the server 40 may initiate a key exchange procedure according to the key management protocol by transmitting a session key to the switch 30, which encrypts and transmits the session key to the AP 20 in accordance with the key management protocol. The AP 20 then uses the session key to create a key message in accordance with the key management protocol, and transmits the key message to the MU 10, which uses the key message to create an encryption key.

It will be apparent to those skilled in the art that various modifications may be made in the present invention, without departing from the spirit or scope of the invention. Although the present invention was discussed with reference to a wireless LAN, the system and method according to the present invention may be applied to any wireless network that includes an AP and a computing device attached via the wired connection. Thus, it is intended that the present invention cover the modifications and variations of this invention provided they come within the scope of the appended claims and their equivalents.

What is claimed is:

1. A system, comprising:
a wireless access point having a first wireless protocol, the access point communicating with a wireless device which has a second wireless protocol, the access point and the wireless device being configured to conduct wireless communications using the first and second wireless protocols; and
a computing device having a third wireless protocol and coupled, via a wire, to the access point, the computing device conducting communications with at least one of the access point and the wireless device using the third wireless protocol.

2. The system according to claim 1, wherein both of the second and third wireless protocols are one of a key management protocol and an encryption protocol.

3. The system according to claim 2, wherein the encryption protocol is one of a wired equivalent privacy, a wi-fi protected access (“WPA”), a WPA2, and a AES-CCMP/802.11i.

4. The system according to claim 1, wherein the communications are one of a data communication, a control communication and a session key.

5. The system according to claim 1, wherein the computing device is one of a switch, a router and a server.

6. A method, comprising the steps of:
encrypting, by a first computing device, a communication using a first wireless protocol; and
transmitting the encrypted communication via a wire to a second computing device with a second wireless protocol, wherein the second wireless protocol provides for decryption of the communication.

7. The method according to claim 6, further comprising:
detecting, by the first computing device, a network event; and
generating the communication as a function of the network event.

8. The method according to claim 6, further comprising:
receiving the communication from a wireless device, the communication being encrypted by the wireless device using a third wireless protocol; and
decrypting, by the first computing device, the communication using the first wireless protocol.

9. The method according to claim 6, wherein the first computing device is one of (i) a wireless access point and (ii) one of a switch, a server and a router and the second computing device is the other of the one of (i) the wireless access point and (ii) the switch, the server and the router.

10. The method according to claim 6, wherein both of the first and second wireless protocols are one of a key management protocol and an encryption protocol.

11. The method according to claim 10, wherein the encryption protocol is one of a wired equivalent privacy, a wi-fi protected access (“WPA”), a WPA2, and a AES-CCMP/802.11i.

12. The method according to claim 6, wherein the communications are one of a data communication, a control communication and a session key.

13. A computing device, comprising:
a memory storing a first wireless protocol; and
a processor using the first wireless protocol to decrypt a communication received via a wire from a further computing device, wherein the communication was encrypted by the further computing device using a second wireless protocol.

14. The device according to claim 14, wherein the computing device is one of (i) a wireless access point and (ii) one of a switch, a server and a router and the further computing device is the other of the one of (i) the wireless access point and (ii) the switch, the server and the router.

15. The device according to claim 14, wherein both of the first and second wireless protocols are one of a key management protocol and an encryption protocol.

16. The device according to claim 16, wherein the encryption protocol is one of a wired equivalent privacy, a wi-fi protected access (“WPA”), a WPA2, and a AES-CCMP/802.11i.

17. The device according to claim 16, wherein the communication is one of a data communication, a control communication and a session key.
